(19) United States
(12) Patent Application Publication
(10) Pub. No.: US 2023/0409815 A1
(43) Pub. Date: Dec. 21, 2023

(54) DOCUMENT PROCESSING METHOD AND APPARATUS, AND DEVICE AND MEDIUM

(71) Applicant: BEIJING ZITIAO NETWORK TECHNOLOGY CO., LTD., Beijing (CN)

(72) Inventor: Longteng PENG, Beijing (CN)

(21) Appl. No.: 18/458,704

(22) Filed: Aug. 30, 2023

Related U.S. Application Data
(63) Continuation of application No. PCT/CN2022/078732, filed on Mar. 2, 2022.

(30) Foreign Application Priority Data
Mar. 2, 2021 (CN) 202110232055.5

(51) Int. Cl. G06F 40/166; G06F 3/0481; G06F 40/263; G06F 40/284; G06F 21/62; G06F 16/14; G06F 16/93

(52) U.S. Cl. CPC G06F 40/166; G06F 3/0481; G06F 40/263; G06F 40/284; G06F 21/6218; G06F 16/148; G06F 16/93

(57) ABSTRACT

Provided are a document processing method, a device and a medium. The document processing method comprises: acquiring, in response to receiving an editing operation performed by a first user on a target document, edit content; sending, based on the edit content, a first data request to a server; and updating, in response to receiving a ubiquitous language identifier sent by the server, a target content in the edit content to be in a ubiquitous language, wherein the ubiquitous language identifier is determined based on the edit content.

This application is a continuation application of PCT/CN2022/078732, filed on Mar. 2, 2022, which claims priority to Chinese Patent Application No. 202110232055.5, titled “DOCUMENT PROCESSING METHOD AND APPARATUS, AND DEVICE AND MEDIUM”, filed on Mar. 2, 2021 with the China National Intellectual Property Administration, both of which are incorporated herein by reference in their entirties.

### FIELD

The present disclosure relates to information processing technology, in particular to a method, apparatus and device for document processing and a medium.

### BACKGROUND

When users use documents to record professional information, they will write relevant information into the documents. Different teams involve different knowledge fields, even different users in the same team are responsible for different technical fields. As a result, users in the team need to use a ubiquitous language to describe a concept and have to maintain the ubiquitous language without including other ambiguities to facilitate summary and clear explanation, which facilitates subsequent knowledge dissemination and information alignment.

However, in the conventional technologies, there is no effective method for managing the ubiquitous languages in online documents.

### SUMMARY

A method, apparatus and device for document processing and a medium are provided according to the embodiments of the present disclosure, which effectively manage ubiquitous languages in online documents.

In a first aspect, a method for document processing is provided according to the present disclosure. The method includes:
acquiring, in response to receiving an editing operation performed by a first user on a target document, edit content;
sending, based on the edit content, a first data request to a server;
updating, in response to receiving a ubiquitous language identifier sent by the server, a target content in the edit content to be in a ubiquitous language, where the ubiquitous language identifier is determined based on the edit content.

In a second aspect, a method for document processing is further provided according to the present disclosure. The method is applied to a server, which includes:
receiving a first data request sent by a client device, where the first data request includes edit content;
acquiring, based on the edit content, a ubiquitous language identifier corresponding to the edit content; and
sending the ubiquitous language identifier corresponding to the edit content to the client device.

In a third aspect, an apparatus for document processing is further provided according to the present disclosure. The apparatus includes:
a content acquisition module, configured to acquire edit content in response to receiving an editing operation performed by a first user on a target document;
a request sending module, configured to send a first data request to a server based on the edit content; and
a ubiquitous language updating module, configured to update a target content in the edit content to be in the ubiquitous language in response to receiving a ubiquitous language identifier sent by the server, and the ubiquitous language identifier is determined based on the edit content.

In a fourth aspect, an apparatus for document processing is further provided according to the present disclosure. The apparatus is configured in a server, which includes:
a request receiving module, configured to receive a first data request sent by a client device, where the first data request includes edit content;
a ubiquitous language identifier acquisition module, configured to acquire a ubiquitous language identifier corresponding to the edit content based on the edit content; and
a ubiquitous language identifier sending module, configured to send the ubiquitous language identifier corresponding to the edit content to the client device.

In a fifth aspect, a device for document processing is further provided according to the present disclosure. The device for document processing includes:
one or more processors; and
a memory, configured to store one or more programs;
where, the one or more programs, when executed by the one or more processors, cause the one or more processors to implement the method for document processing according to any one of the embodiments of the present disclosure.

In a six aspect, a medium is further provided according to the present disclosure. The medium storing a computer program thereon, where the computer program, when executed by a processor, implements the method for document processing according to any one of the embodiments of the present disclosure.

### BRIEF DESCRIPTION OF THE DRAWINGS

In conjunction with the drawings and with reference to the following embodiments, the above and other features, advantages and aspects of the embodiments of the present disclosure are more apparent. The same or similar reference numerals represent the same or similar elements through the drawings. It should be understood that the drawings are schematic and the components and elements are unnecessarily drawn to scale.

FIG. 1 is a flowchart of a method for document processing according to an embodiment of the present disclosure;

FIG. 2 is a schematic diagram of a first interaction area according to an embodiment of the present disclosure;

FIG. 3 is a schematic diagram of a second interaction area according to an embodiment of the present disclosure;

FIG. 4 is a schematic diagram of a document operation page according to an embodiment of the present disclosure;

FIG. 5 is a flowchart of a method for document processing according to an embodiment of the present disclosure;

FIG. 6 is a flowchart of an interactive method for document processing according to an embodiment of the present disclosure;

FIG. 7 is a flowchart of an interactive method for document processing according to an embodiment of the present disclosure;

FIG. 8 is a flowchart of an interactive method for document processing according to an embodiment of the present disclosure;

FIG. 9 is a schematic structural diagram of an apparatus for document processing according to an embodiment of the present disclosure;

FIG. 10 is a schematic structural diagram of an apparatus for document processing according to an embodiment of the present disclosure; and

FIG. 11 is a structural diagram of an electronic device according to an embodiment of the present disclosure.

### DETAILED DESCRIPTION OF EMBODIMENTS

The embodiments of the present disclosure are described in detail below with reference to the drawings. Although some embodiments of the present disclosure are shown in the drawings, it should be understood that the present disclosure may be implemented in various forms and should not be limited to the embodiments described herein. Rather, the embodiments are provided for thoroughly and completely understanding the present disclosure. It should be understood that the drawings and the embodiments of the present disclosure are exemplary and are not intended to limit the protection scope of the present disclosure.

It should be understood that the steps in the method embodiments of the present disclosure may be performed in different orders and/or in parallel. In addition, the method embodiments may include an additional step and/or a step shown herein may be omitted. The scope of the present disclosure is not limited in this aspect.

The term “include” and its variations in the present disclosure means open-ended inclusion, i.e., “including but not limited to”. The term “based on” means “based at least in part on”. The term “one embodiment” means “at least one embodiment”. The term “another embodiment” means “at least one additional embodiment”. The term “some embodiments” means “at least some embodiments”. The definitions of other terms are provided in the following descriptions.

It should be noted that the wordings such as “first” and “second” used in the present disclosure are used to distinguish different apparatuses, modules or units, and are not used to limit a sequential order or interdependence of the functions performed by the apparatuses, modules or units.

It should be noted that the wordings such as “one” and “multiple” used in the present disclosure are illustrative and not restrictive. Those skilled in the art should understand that the wordings should be understood as “one or more” unless otherwise expressly indicated in the context.

The names of messages or information exchanged between multiple apparatuses in the embodiments of the present disclosure are only for illustrative purposes, and are not intended to limit the scope of the messages or information.

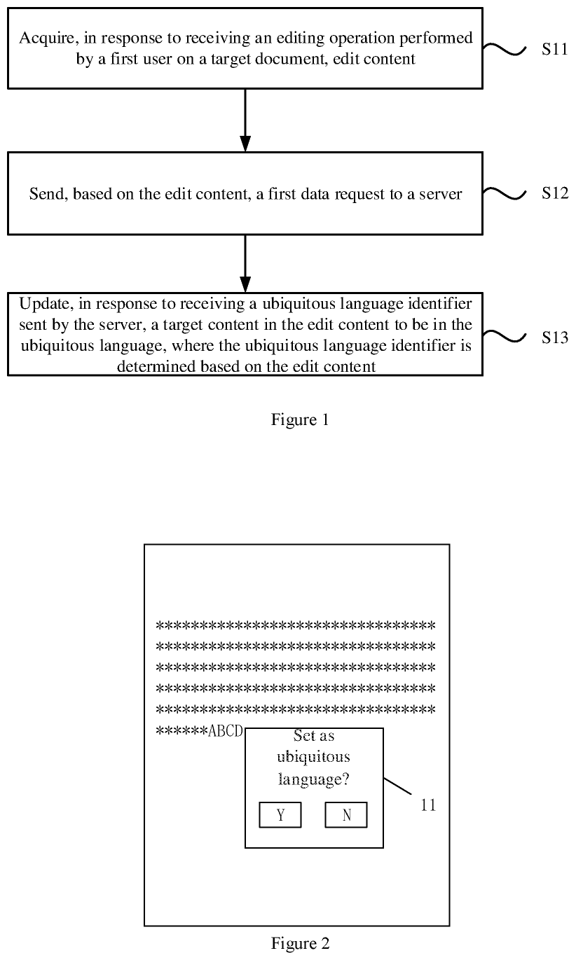

FIG. 1 illustrates a flowchart of a method for document processing according to an embodiment of the present disclosure. This embodiment is applicable to the management of the ubiquitous languages in a document. The method can be implemented by an apparatus for document processing. The apparatus may be realized by means of software and/or hardware. The method for document processing is applied in the client device.

It should be noted that the method for document processing provided in this embodiment may be applied on the client device, and may be considered to be implemented by the apparatus for document processing integrated in the client device. The client device may specifically be a computer device including a processor, a memory, input apparatus, and output apparatus. For example, the computer device may be a notebook computer, desktop computer, tablet computer and smart terminal.

As shown in FIG. 1, the method for document processing, provided by this embodiment, mainly includes steps S11, S12 and S13 as follows.

In S11, in response to receiving an editing operation performed by a first user on a target document, edit content is acquired.

The target document may be an editable document displayed in the display area of the client device, for example, it may be a common document such as a word document, an excel document, a pdf document, a txt document, or other editable documents, which is not limited in this embodiment. The edit content refers to the content inputted by the operator on the current document page, which may be the content inputted by the user through pasting, or the content inputted by the user through the inputting method. In this embodiment, the edit content is merely an illustration rather than a limitation.

In S12, based on the edit content, a first data request is sent to a server.

The server may be a background server or a back-end server, which provides computing or application services for client devices in the network. It has the ability to respond to service requests, undertake services, and guarantee services. It has high-speed CPU computing capabilities, long-term reliable operation, powerful I/O external data throughput capabilities, and better scalability.

The edit content is included in the first data request, and the first data request is used to request the server to identify whether there is a ubiquitous language in the edit content. In a case that the server identifies a ubiquitous language identifier corresponding to the edit content, it sends the ubiquitous language identifier to the client device.

In S13, in response to receiving a ubiquitous language identifier sent by the server, a target content in the edit content is updated to be in a ubiquitous language, where the ubiquitous language identifier is determined based on the edit content.

The ubiquitous language refers to the language used by a working team to describe same concepts or knowledge points. The working team maintains the ubiquitous language without including other ambiguities to facilitate summary and clear explanation, which facilitates subsequent knowledge dissemination and information alignment.

In an embodiment, the ubiquitous language is widely used by all participants in the team in the process of software development based on Domain-driven design (DDD), so that the description of business rules can be accurately transmitted, which is convenient for team members to reach an agreement on terminology identification. In this way, it is convenient for understanding and dissemination. The ubiquitous language identifier indicates that each ubiquitous language has a unique identification ID, through which the name of the corresponding ubiquitous language and the corresponding definition can be identified. The target content refers to part of or all of the edit content.

In this embodiment, the client device receives the edit content inputted by the first user on the target document page, generates the first data request based on the edit content, and sends the first data request to the server. Then, the server identifies whether there is a ubiquitous language identifier corresponding to the edit content. In a case that there is a ubiquitous language identifier corresponding to the edit content, the ubiquitous language identifier is returned to the client device. The client device automatically updates the target content in the edit content to be in the ubiquitous language according to the received ubiquitous language identifier sent by the server. In a case that there is no ubiquitous language identifier corresponding to the edit content, the server takes no action. The ubiquitous language identifier corresponding to the edit content refers to the situation that there is a ubiquitous language identifier corresponding to a part of or all of the edit content.

In the embodiment of the present disclosure, the target content in the edit content is automatically updated to be in a ubiquitous language, which can be understood as directly updating the target content to be in a ubiquitous language after receiving the ubiquitous language identifier sent by the server, without manual intervention, which is convenient and fast.

In one embodiment, in response to receiving the ubiquitous language identifier sent by the server, updating the target content in the edit content to be in a ubiquitous language includes: presenting a first interaction area, where the first interaction area is associated with the target content in the edit content; and in response to receiving a first operation performed by the first user on the first interaction area, updating the target content in the edit content to be in the ubiquitous language.

The interaction area may be understood as a display area presented in the target document where the first user can interact with the client device. Further, the interaction area may be a preset area in the target document page or may be the area where the cursor is located in the target document. The preset area may be at a preset fixed position or may change along with the position of the edit content. For example, the preset position may be the bottom, top, left or right of the document page. The change along with the position of the edit content may be at the lower right, upper right or lower left of the edit content.

In this embodiment, the server returns the ubiquitous language identifier corresponding to the target content to the client device, and the client device displays information associated with the target content in the first interaction area. The associated information is used to prompt the first user whether to update the target content to be in a ubiquitous language.

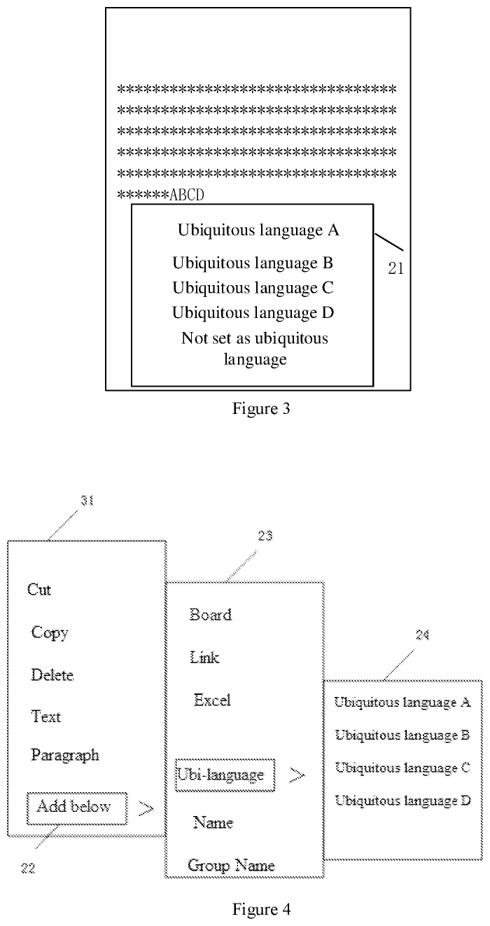

FIG. 2 is a schematic diagram of a first interaction area according to an embodiment of the present disclosure. As shown in FIG. 2, “Set as ubiquitous language?” is displayed in the first interaction area 11 with two selection buttons, i.e., the “Yes” button and the “No” button.

Further, in response to the first operation performed by the first user on the first interaction area, the target content in the edit content is updated to be in a ubiquitous language. In response to a triggering operation performed by the first user on the first interaction area, no action is taken on the edit content.

In an example, the first operation may be a triggering operation on the “Yes” button in the first interaction area 11, and the target content in the edit content is updated to be in the ubiquitous language. Further, the triggering operation may be a triggering operation on the “No” button in the first interaction area 11. The triggering operation on the button may be a single-click, double-click or touch operation on the button, which is not limited in this embodiment.

Specifically, after receiving the triggering operation performed by the first user on the “Yes” button, in response to the operation, the target content is updated to be in the ubiquitous language. After receiving the triggering operation performed by the first user on the “No” button, in response to the operation, no action is taken on the target content, and the target content is still ordinary edit content.

It should be noted that the first interaction area and the operation mode shown in FIG. 2 are only exemplary rather than limiting, i.e., other settings may be made according to actual page display scenarios.

In one embodiment, the updating a target content in the edit content to be in the ubiquitous language in response to receiving a ubiquitous language identifier sent by the server includes: presenting a second interaction area, where the second interaction area includes ubiquitous language identifiers associated with the target content in the edit content; acquiring, in response to receiving a second operation performed by the first user on the second interaction area, the ubiquitous language identifier corresponding to the target content; and updating, in response to receiving a third operation performed by the first user on the second interaction area, the target content in the edit content to be in the ubiquitous language corresponding to the ubiquitous language identifier.

In this embodiment, the server identifies that the target content in the edit content corresponds to multiple ubiquitous language identifiers. The server then returns multiple ubiquitous language identifiers corresponding to the target content to the client device, and the client device displays the multiple ubiquitous language identifiers associated with the target content in the second interaction area.

FIG. 3 is a schematic diagram of a second interaction area according to an embodiment of the present disclosure. As shown in FIG. 3, the first interaction area 21 is displayed in the lower right corner of the edit content, and the first interaction area 21 includes multiple ubiquitous language identifiers, for example, ubiquitous language A, ubiquitous language B, ubiquitous language C, ubiquitous language D and options such as not set as ubiquitous language. In the second interaction area, the operator may select the ubiquitous language identifier corresponding to the target content.

Exemplarily, once detecting a clicking operation performed by the first user on the option of “Not set as ubiquitous language” in the second interaction area, the target content is only stored as regular text without any further action.

Further, while receiving the ubiquitous language identifiers sent by the server, the matching degree between each ubiquitous language identifier and the target content may be received, and the order of the ubiquitous language identifiers in the second interaction area is determined by the matching degrees. For example, the top-to-bottom order of the ubiquitous language identifiers in the second interaction area is the descending order of the matching degrees of the corresponding target content with the ubiquitous language identifiers. The ubiquitous language identifier with the highest matching degree is displayed on the top, followed by the ubiquitous language identifiers with descending matching degrees.

In one embodiment, in response to receiving the second operation performed by the first user on the second interaction area, the ubiquitous language identifier corresponding to the target content is acquired and the target content is directly set to be in the ubiquitous language corresponding to the ubiquitous language identifier.

For example, once detecting a clicking operation performed by the first user on the option of “Ubiquitous language A” in the second interaction area, the ubiquitous language identifier A is acquired, and the target content is directly updated to be in the ubiquitous language corresponding to the ubiquitous language identifier A.

In one embodiment, in response to receiving the second operation performed by the first user on the second interaction area, the ubiquitous language identifier corresponding to the target content is acquired, and the display content in the second interaction area is updated. At this time, the information associated with the target content is displayed in the interaction area. In response to receiving a third operation performed by the first user on the second interaction area, the target content is updated to be in the ubiquitous language corresponding to the ubiquitous language identifier. The processing in response to receiving the third operation performed by the first user on the second interaction area is similar to the processing in response to the first operation in the first interaction area, and reference may be made to the description of the first operation in the first interaction area in the above embodiments for details, which will not be repeated in this embodiment. The associated information is used to prompt the first user whether to set the target content to be in a ubiquitous language.

In one embodiment, the updating a target content in the edit content to be in the ubiquitous language in response to receiving a ubiquitous language identifier sent by the server includes: presenting a third interaction area, in a case that multiple target contents are included in the edit content, where the third interaction area includes ubiquitous language identifiers associated with the multiple target contents; matching the target contents with corresponding ubiquitous language identifiers, in response to receiving a fourth operation performed by the first user on the third interaction area; and updating the target contents in the edit content to be in ubiquitous languages corresponding to the matched ubiquitous language identifiers, in response to receiving a fifth operation performed by the first user on the third interaction area.

In this embodiment, the server identifies that there are multiple target contents in the edit content each corresponding to a ubiquitous language identifier. The server returns multiple ubiquitous language identifiers corresponding to the target contents to the client device. In the third interaction area, the client device displays the multiple ubiquitous language identifiers associated with the multiple target contents. In response to receiving the fifth operation performed by the first user on the third interaction area, the client device updates the target contents in the edit content to be in the ubiquitous languages corresponding to the matched ubiquitous language identifiers.

For example, multiple target contents in the edit content each corresponding to a ubiquitous language identifier can be understood as: target content a corresponds to ubiquitous language identifier A, target content b corresponds to ubiquitous language identifier B, target content c corresponds to ubiquitous language identifier C, and target content d corresponds to ubiquitous language identifier D.

Based on the above embodiments, before acquiring the edit content in response to receiving an editing operation performed by the first user on the target document, the method further includes: in response to an operation performed by the first user on a mode switch, enabling the ubiquitous language identification mode for the user identifier.

Specifically, a mode switch may be set in the document. The mode switch is used to enable or disable the ubiquitous language identification mode. The ubiquitous language identification mode refers to automatically identifying whether the edit content is a ubiquitous language once the user inputs the edit content.

In a case that the ubiquitous language identification mode is enabled, once the user inputs the edit content, whether the edit content is in a ubiquitous language is automatically identified, that is, to implement the method for document processing provided by the embodiments of the present disclosure, such as the above steps S11-S13. In a case that the ubiquitous language identification mode is disabled, once the user inputs the edit content, the edit content is stored as regular edit text without identifying the ubiquitous language.

Further, when the ubiquitous language identification mode is disabled, the ubiquitous language identification mode is enabled in response to the operation on the mode switch. The operation on the mode switch includes single-clicking, double-clicking, or touching the mode switch. In a case that the ubiquitous language identification mode is enabled, the ubiquitous language identification mode is disabled in response to the operation on the mode switch. The operation on the mode switch includes single-clicking, double-clicking, or touching the mode switch.

According to the embodiments of the present disclosure, the method for document processing includes: acquiring edit content, in response to receiving an editing operation performed by a first user on a target document; sending, based on the edit content, a first data request to a server; in response to receiving a ubiquitous language identifier sent by the server, updating a target content in the edit content to be in a ubiquitous language, where the ubiquitous language identifier is determined based on the edit content. In the embodiment of the present disclosure, during the process of editing the online document, in a case that the inputted edit content includes a ubiquitous language, the target content in the edit content is automatically updated to be in the ubiquitous language. In this way, the ubiquitous languages in the online document can be managed effectively.

Based on the above embodiments, a method for document processing is provided according to another embodiment of the present disclosure. The method for document processing includes displaying, in the target document, the ubiquitous language, in response to an inserting operation for the ubiquitous language.

In this embodiment, the inserting operation for the ubiquitous language can be understood as an operation of inserting the ubiquitous language in the target current document. The inserting operation may be performed by right-clicking, or by the insert button in the function box at the top of the document, which is not limited in this embodiment.

In one embodiment, the displaying the ubiquitous language in the target document in response to the inserting operation for the ubiquitous language includes: presenting a first operation entry in response to the inserting operation for the ubiquitous language, where the first operation entry is used to acquire a target ubiquitous language; presenting a second operation entry, in response to acquiring the target ubiquitous language; and displaying, in the target document, the target ubiquitous language, in response to receiving an operation instruction on the second operation entry.

The second operation entry includes one or more operation entries with respect to the target ubiquitous language. The operation instruction on the second operation entry may include single-clicking, double-clicking or touching on any option in the second operation entry.

Further, the inserting operation for the ubiquitous language may be performed through the insert button at the top of the document, in which all options for inserting content in the document, including the first operation entry, are presented, in response to the operation for the ubiquitous language option corresponding to the first operation entry. Alternatively, an insertion selection box may be displayed in the target document, and all options for adding content in the document are displayed in the insertion selection box, including the first operation entry, in response to the operation for the ubiquitous language option corresponding to the first operation entry.

Further, in response to the operation for the ubiquitous language option in the first operation entry, the target ubiquitous language is acquired. In response to acquiring the target ubiquitous language, a second operation entry is presented. In response to the operation on the second operation entry, a target ubiquitous language is selected from the multiple target ubiquitous languages. The target content inputted by the first user in the target document is received, and then the target content is updated to be in a ubiquitous language.

In an exemplary implementation, FIG. 4 is a schematic diagram of a document operation page according to an embodiment of the present disclosure. As shown in FIG. 4, a function list box 31 as shown in FIG. 4 is presented in the target document by clicking the right mouse button at any position in the target document or performing a selection operation in the function bar at the top of the document. When operating on the “Add below” option 22 in the function list, the adding selection box 23 as shown in FIG. 4 is presented in the current document. When operating on the first operation entry “Ubiquitous Language” option in the adding selection box 23, the second selection box 24 is presented in the target document. As shown in FIG. 4, the second selection box 24 includes second operation entry, e.g., Ubiquitous Language A, Ubiquitous Language B, Ubiquitous Language C, Ubiquitous Language D. The operator can arbitrarily select a ubiquitous language ID to be the ubiquitous language corresponding to the edit content subsequently inputted in the document next.

It should be noted that, FIG. 4 only illustrates but not to limit the scheme for inserting the ubiquitous language.

In one embodiment, the displaying the ubiquitous language in the target document in response to an inserting operation for the ubiquitous language includes: acquiring target location information in response to the insertion operation for the ubiquitous language; and displaying the ubiquitous language in the target document based on the target location information.

In this embodiment, the target location information indicate the location where the ubiquitous language is inserted, and the location information is realized by the inserting operation performed by the first user for the ubiquitous language. The first user can insert the ubiquitous language anywhere in the target document.

Further, after the target ubiquitous language is acquired based on the above embodiment, the target content subsequently inputted by the first user at the target location is updated to be in the target ubiquitous language.

In an embodiment, based on the above embodiment, the method further includes: establishing an association relationship between the target content in the edit content and the ubiquitous language identifier; and storing the association relationship in a mapping relationship table.

The ubiquitous language identifier may be the ubiquitous language identifier selected by the first user from the first interaction area, the second interaction area or the third interaction area in the above embodiments.

The correspondence relationship between the target content and the selected ubiquitous language identifier is established. It should be noted that the relationship between the target content and the ubiquitous language identifier may be one-to-one correspondence or many-to-one correspondence. That is, different target contents may use the same ubiquitous language identifier.

The mapping relationship table stores the correspondence relationship between the target content and the ubiquitous language identifier, so that the operator may easily acquire the ubiquitous language ID corresponding to the target content in subsequent usage of the document.

Further, based on the above embodiments, the method further includes: switching a display mode of the target content in the edit content from a first mode to a second mode in response to a current editing mode being a first mode; or switching the display mode of the target content in the edit content from a third mode to a second mode associated with the third mode in response to a current editing mode being the third mode.

In this embodiment, the first mode can be understood as a display mode of regular content in the target document. The second mode refers to a dedicated display mode for the target content in the ubiquitous language.

For example, the first display mode is a font of SimSun with a size of four. The second display mode may be a display manner such as adding an underline, adding a text background, bold, or italic.

In this embodiment, the third mode can be understood as a display mode in which rendering has been added on the basis of the display mode of regular content in the target document. The second mode refers to the dedicated display mode for the target content in the ubiquitous language.

It should be noted that the difference between the third display mode and the first display mode is that the first mode is only a basic display of document content, while the third display mode is added with rendering on the basis of the first mode. The second display mode associated with the third mode is to add a rendering display mode on the basis of the third mode.

For example, the first display mode is a font of SimSun with a size of four. The third pattern is a font of SimSun with a size of four, in bold. Correspondingly, the second display mode associated with the third mode is a font of SimSun with a size of four, in bold and underlined. Or the second display mode associated with the third mode is a font of SimSun with a size of four, in bold, adding text background.

By displaying the target content differently, the operator can clearly notice which content is in the ubiquitous language when using the document subsequently.

On the basis of the above embodiments, the method for document processing further includes: in response to a triggering operation on the updated target content, sending a second data request to the server, where the second data request includes a ubiquitous language identifier and an identifier of the target document; in response to receiving the second data sent by the server, presenting ubiquitous language description information corresponding to the ubiquitous language identifier.

In this embodiment, the triggering operation on the updated target content may be a selection operation on the updated target content, or a clicking operation on the updated target content, or may be an operation that a mouse cursor points to the updated target content. The ubiquitous language description information refers to detailed explanation information of the ubiquitous language corresponding to the target content.

The second data request is mainly used for the client device to request detailed explanation information of the ubiquitous language corresponding to the target content from the server.

In this embodiment, in response to a triggering operation on the updated target content, a second data request is sent to the server. The server determines a corresponding preset mapping relationship table based on the identifier of the target document, and performs a query based on the target content in the preset mapping relationship table. In a case that the ubiquitous language identifier corresponding to the target content is found in the preset mapping relationship table, it indicates that the target content of the current operation is in a ubiquitous language. Then, the ubiquitous language description information corresponding to the target content is acquired based on the ubiquitous language identifier and sent to client device for presenting.

Further, after receiving the ubiquitous language description information corresponding to the target content returned by the server, the client device may present the ubiquitous language description information in a definition presenting box.

The definition presenting box may be displayed in the target document in various manners. For example, the definition presenting box may be displayed in a preset area on the target document page. Or the definition presenting box may be displayed on the area where the cursor is located in the document area. The definition presenting box is a box floating on the document. The preset area may be at a preset fixed position, or at a position that changes along with the content of the document. For example, the preset position may be the bottom, top, left or right of the document page. The position that changes along with the content of the document may be the lower right, upper right or lower left of the edit content.

As an example, the definition presenting box is set at the bottom of the document. In a case that the operator needs to view the specific content of the ubiquitous language corresponding to the target content “ABCD” while browsing the document, the operator may place the cursor of the mouse on the target content “ABCD” or click the target content “ABCD” with the mouse. After detecting the operation of the operator, the client device sends a second data request to the server. The server returns the ubiquitous language description information corresponding to the target content, and the ubiquitous language description information is presented in the definition presenting box in the target document. Further, after the operator finish viewing, the operator may close the definition presenting box through the close button of the definition presenting box; or may close the definition presenting box by operating on the document content “ABCD” again.

In the technical solution of this embodiment, when the operator places the mouse on the ubiquitous language, there will be a floating window to present and analyse the specific meaning of the ubiquitous language.

On the basis of the above embodiments, the method for document processing further includes: receiving a name of the ubiquitous language and ubiquitous language description information, in response to an adding operation for the ubiquitous language; sending the name of the ubiquitous language and the ubiquitous language description information to the server, to allow the server to create a corresponding ubiquitous language record.

The name of ubiquitous language may be the name defined by the operator for the ubiquitous language.

In this embodiment, the client device may receive the instruction inputted by the user in the document for establishing or updating a ubiquitous language database, receive the name of the ubiquitous language and ubiquitous language description information input by the user in response to the adding operation for the ubiquitous language, and request for an interface of the ubiquitous language database of the server to transfer the name of the ubiquitous language and the corresponding ubiquitous language description information. After receiving the request, once the server determines that there is no duplicate ubiquitous language, it generates a ubiquitous language record, updates the ubiquitous language database, and returns the processing result to the client device.

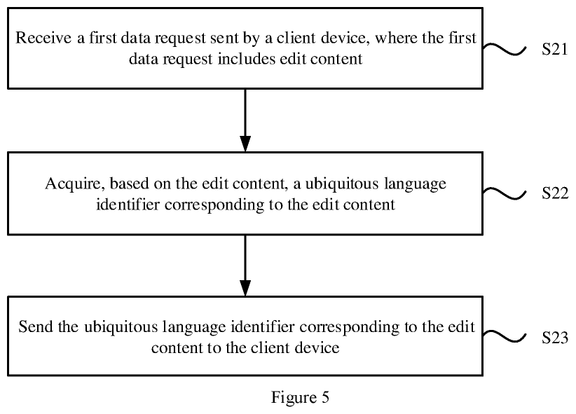

FIG. 5 is a flowchart of a method for document processing according to an embodiment of the present disclosure. This embodiment is applicable in management of ubiquitous languages in a document. The method may be implemented by the apparatus for document processing. The apparatus may be realized by means of software and/or hardware. The method for document processing is applied to the server.

As shown in FIG. 5, the method for document processing, provided by this embodiment, mainly includes steps S21, S22 and S23.

In S21, a first data request sent by the client device is received, where the first data request includes edit content.

The server may be a background server or a back-end server, which provides computing or application services for client devices in the network. It can respond to service requests, undertake services, and guarantee services. It has high-speed CPU computing capabilities, long-term reliable operation, powerful I/O external data throughput capabilities, and better scalability.

Furthermore, the server serves the client device. A communication connection is established between the client device and the server for data interaction and transmission.

Specifically, the client device receives the edit content inputted by the operator on the target document page, generates a first data request based on the edit content, and sends the first data request to the server. Correspondingly, the server receives the first data request sent by the client device.

In S22, based on the edit content, a ubiquitous language identifier corresponding to the edit content is acquired.

In one embodiment, based on the edit content, a ubiquitous language identifier corresponding to the edit content is acquired, which includes: performing aggregation processing on data information corresponding to at least one edit content, and determining a total amount of data information after the aggregation processing; in a case that the total amount of data information meets a threshold condition, acquiring the ubiquitous language identifier corresponding to the edit content.

The threshold condition refers to a condition for querying the corresponding ubiquitous language identifier based on the edit content. The threshold condition may be an attribute feature of the edit content. For example, it may be the number of words, text format, font size of the edit content and the like.

In this embodiment, Binlogs in the MySQL database are monitored. Multiple Binlogs corresponding to the target document are acquired. And then, modifications corresponding to the multiple Binlogs are aggregated into one modification, and the specific modified content is extracted. When the number of words in the specific modified content meets the threshold condition, the ubiquitous language identifier corresponding to the edit content is acquired.

MySQL database is an open-source determinant database that can store user data. Binlogs are binary logs maintained by the MySQL database service layer. Binlog is mainly used to record SQL statements that update or potentially update MySQL data and is stored on disk in the form of “transactions”. In a word, Binlog records every action of operating the database. The actions of operating MySQL can be repeated through Binlogs like a movie.

Specifically, each time the user finishes the inputting operation in the target document page, the corresponding modified content will be written into the MySQL database. After receiving the edit content sent by the client device, the ubiquitous language module asynchronously monitors the Binlogs of the MySQL database and parses the Binlogs. In this embodiment, delay queue consumption is used, where multiple Binlog records of a certain document are consumed each time, and then the corresponding modifications are aggregated into one modification. In the end, the specific modified content is extracted. In a case that the increased number of words in the specific modified content exceeds the threshold condition, the ubiquitous language identifier corresponding to the edit content is acquired.

Preferably, the threshold condition in this embodiment is 10 characters. It should be noted that the threshold condition of 10 characters is obtained based on experience. The threshold condition may be set according to practical application conditions. This embodiment is only an illustration rather than a limitation.

In one embodiment, the acquiring the ubiquitous language identifier corresponding to the edit content based on the edit content includes: performing tokenization processing on the edit content to obtain multiple tokens corresponding to the edit content; determining a ubiquitous language identifier corresponding to each token by matching each token in a ubiquitous language database.

In an embodiment, tokenization processing is performed on the edit content locally, the corresponding tokens are extracted from the edit content, and the tokens are accurately matched in the ubiquitous language ElasticSearch database.

Any tokenization processing strategy may be used for the tokenization processing, such as the Jieba Chinese tokenization strategy. In this embodiment, the tokenization strategy is only an illustration rather than a limitation.

In another embodiment, querying the ubiquitous language identifier corresponding to the edit content includes performing fuzzy matching on the edit content in the ubiquitous language database to determine the query result.

Specifically, fuzzy search is performed in the ElasticSearch database for the untokenized edit content.

The ElasticSearch is a search engine based on Lucene database. It provides a distributed, multi-tenant capable full-text search engine.

In another embodiment, accurate matching for the tokens is performed in the ubiquitous language ElasticSearch database, and fuzzy search is performed for the untokenized edit content in the ElasticSearch database. And the query result is determined according to the results of the two searches.

In this embodiment, the query speed can be improved by accurately matching tokens in the ubiquitous language ElasticSearch database. In addition, the query recall rate can be improved by fuzzy searching for the untokenized edit content in the ElasticSearch database.

In S23, the ubiquitous language identifier corresponding to the edit content is sent to the client device.

In one embodiment, in a case that no ubiquitous language identifier corresponding to the edit content is found, no content is returned.

In another embodiment, in a case that one or more ubiquitous language identifiers are queried, different processing may be performed according to the number of queried ubiquitous language identifiers.

Specifically, in a case that the number of queried ubiquitous language identifiers is less than or equal to a preset threshold, all queried ubiquitous language identifiers may be returned to the client device. The ubiquitous language identifiers returned to the client device may be sorted according to the matching degrees from high to low.

Specifically, in a case that the number of the queried ubiquitous language identifiers is greater than the preset threshold, all the queried ubiquitous language identifiers are sorted according to the matching degrees from high to low, and the top L ubiquitous language identifiers are returned to the client device, where L is equal to the preset threshold. The preset threshold may be set according to practical application conditions. For example, it may be 3 or 5.

In another embodiment, sorting may be omitted, and all queried ubiquitous language IDs are returned to the client device.

In this embodiment, the specific operation of automatically identifying the ubiquitous language may be performed only in the case that the ubiquitous language identification mode is enabled for the current user identifier. In a case that the ubiquitous language identification mode is not enabled for the current user identifier, no operation is performed.

In one embodiment, the method for document processing further includes: receiving a second data request sent by the client device; where, the second data request includes a ubiquitous language identifier and an identifier of the target document; querying in the ubiquitous language database for ubiquitous language description information corresponding to the ubiquitous language identifier; sending second data to the client device, the second data including the ubiquitous language description information corresponding to the ubiquitous language identifier.

In this embodiment, after receiving the second data request, the server needs to determine the ubiquitous language description information corresponding to the target content based on the ubiquitous language identifier in the second data request. Specifically, the server determines a corresponding preset mapping relationship table based on the identifier of the target document, and performs a query based on the target content in the preset mapping relationship table. In a case that the ubiquitous language identifier corresponding to the target content is found in the preset mapping relationship table, which indicates that the target content for the current operation is in a ubiquitous language, the ubiquitous language description information corresponding to the target content is acquired based on the ubiquitous language identifier and sent to client device for presenting.

Further, the second data request further includes: a user identifier; the method further includes: based on the user identifier and the identifier of the target document, determining whether the user is authorized with the permission of the target document; in response to the user being authorized with the permission of the target document, querying for the ubiquitous language description information corresponding to the ubiquitous language identifier in the ubiquitous language database.

A query is performed in the table of correspondence relationship between the identifier of the target document and the user identifier to determine whether the user identifier is authorized with the permission of the target document. The permission may refer to the permission for modification, input, deletion, editing and the like. The permission in this embodiment mainly refers to the permission for querying the ubiquitous language identifier.

In a case that the correspondence relationship between the current user identifier and the identifier of the target document can be found in the table of correspondence relationship between the identifier of the document and the user identifier, it is determined that the current user identifier is authorized with the permission of the target document. Then, an operation of querying for the ubiquitous language description information corresponding to the target content under the ubiquitous language identifier in the ubiquitous language database is performed.

In a case that the correspondence relationship between the current user identifier and the identifier of the target document cannot be found in the table of correspondence relationship between the identifier of the document and the user identifier, it is determined that the current user identifier is not authorized with the permission of the current document, and the user is prompted that he does not have the permission to query the ubiquitous language identifier. In this way, the security and confidentiality of documents can be improved.

In one embodiment, the method for document processing further includes: receiving the name of the ubiquitous language and the ubiquitous language description information sent by the client device; querying in the ubiquitous language database based on the name of the ubiquitous language; in response to not finding the name of the ubiquitous language, updating the ubiquitous language database based on the name of the ubiquitous language and the ubiquitous language description information.

In this embodiment, the client device may receive the instruction inputted by the user in the document for establishing or updating the ubiquitous language database, receive the name of the ubiquitous language and ubiquitous language description information inputted by the user in response to an adding operation for the ubiquitous language, and request an interface of the ubiquitous language database of the server to transfer the name of the ubiquitous language and the corresponding ubiquitous language description information. After receiving the request, once the server determines that there is no duplicate ubiquitous language, the server generates a ubiquitous language record, updates the ubiquitous language database, and returns the processing result to the client device.

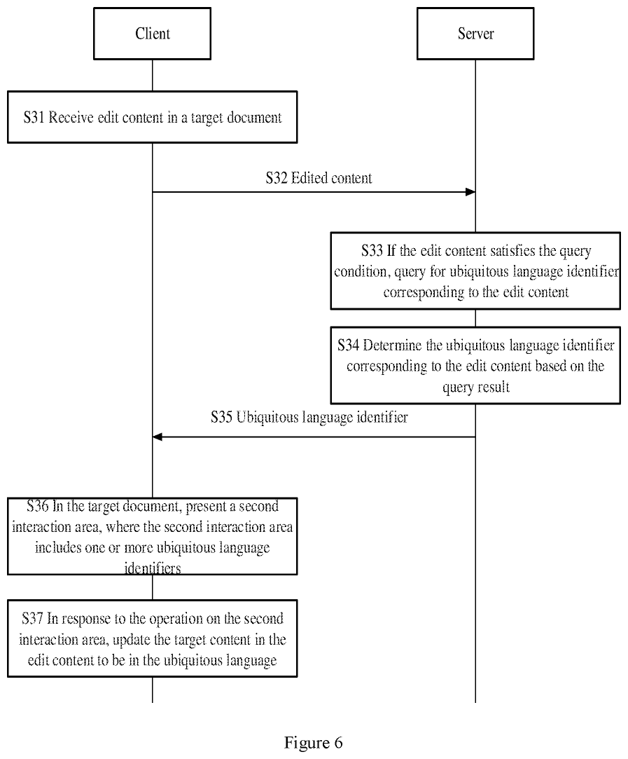

FIG. 6 is a flowchart of an interactive method for document processing according to an embodiment of the present disclosure. As shown in FIG. 6, the interactive method provided in this embodiment mainly includes steps S31 to S37 as follows.

In S31, the client device receives edit content in a target document.

In S32, the client device sends the edit content to the server.

In S33, in a case that the edit content satisfies the query condition, the server queries for the ubiquitous language identifier corresponding to the edit content.

In S34, the server determines the ubiquitous language identifier corresponding to the edit content based on the query result.

In S35, the server sends the ubiquitous language identifier to the client device.

In S36, the client device presents a second interaction area in the target document, where the second interaction area includes one or more ubiquitous language identifiers.

In S37, in response to the operation on the second interaction area, the client device updates the target content in the edit content to be in the ubiquitous language.

The specific implementation of the above steps may refer to the descriptions in the above embodiments, the details of which will not be repeated in this embodiment.

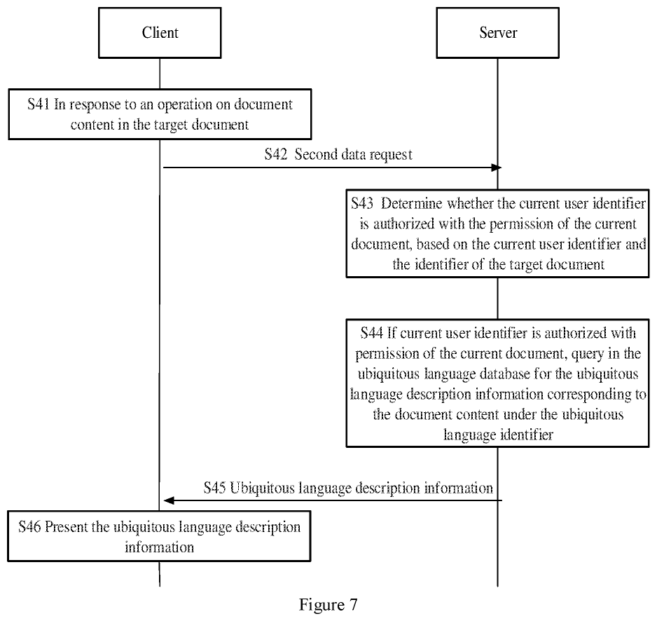

FIG. 7 is a flowchart of an interactive method for document processing according to an embodiment of the present disclosure. As shown in FIG. 7, the interactive method provided in this embodiment mainly includes steps S41 to S46 as follows.

In S41, the client device responds to an operation on document content in the target document.

In S42, the client device sends a second data request to the server.

In S43, the server determines whether the current user identifier is authorized with the permission of the current document, based on the current user identifier and the identifier of the target document.

In S44, in a case that the current user identifier is authorized with the permission of the current document, the server queries in the ubiquitous language database for the ubiquitous language description information corresponding to the document content under the ubiquitous language identifier.

In S45, the server returns the ubiquitous language description information to the client device.

In S46, the client device presents the ubiquitous language description information.

The specific implementation of the above steps may refer to the descriptions in the above embodiments, the details of which will not be repeated in this embodiment.

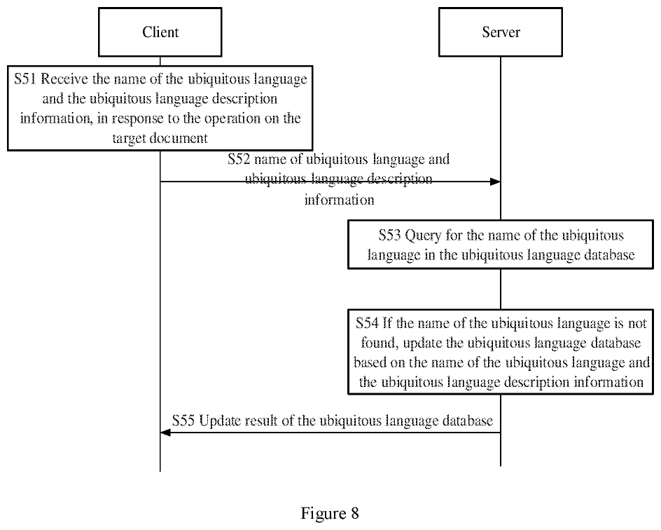

FIG. 8 is a flowchart of an interactive method for document processing according to an embodiment of the present disclosure. As shown in FIG. 8, the interactive method provided in this embodiment mainly includes steps S51 to S55 as follows.

In S51, the client device receives the name of the ubiquitous language and the ubiquitous language description information, in response to the operation on the target document.

In S52, the client device sends the name of the ubiquitous language and the ubiquitous language description information to the server.

In S53, the server queries in the ubiquitous language database based on the name of the ubiquitous language.

In S54, in a case that the server does not find the name of the ubiquitous language, the server updates the ubiquitous language database based on the name of the ubiquitous language and the ubiquitous language description information.

In S55, the server returns the update result of the ubiquitous language database to the client device.

The specific implementation of the above steps may refer to the descriptions in the above embodiments, the details of which will not be repeated in this embodiment.

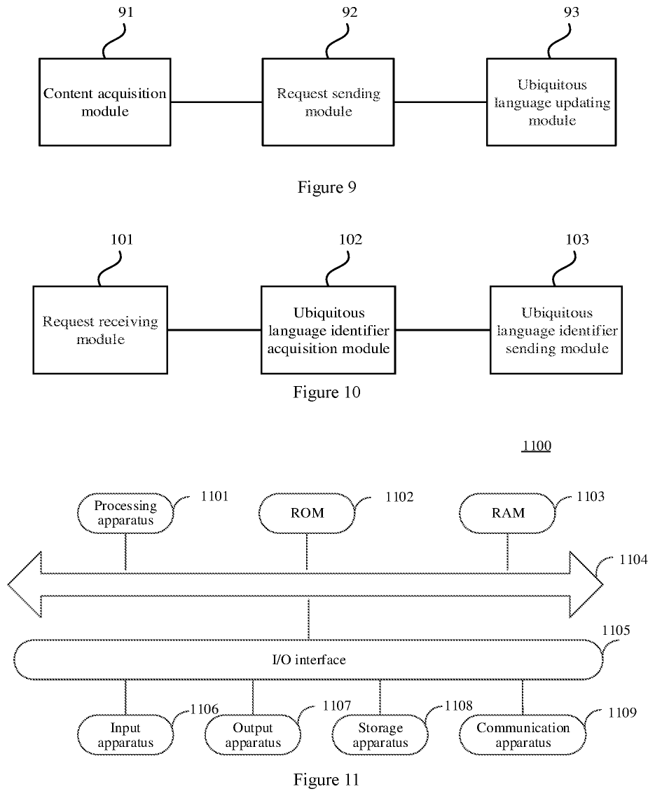

FIG. 9 is a schematic structural diagram of an apparatus for document processing according to an embodiment of the present disclosure. This embodiment is applicable in management of ubiquitous languages in a document. The apparatus may be implemented by means of software and/or hardware. The apparatus for document processing is configured in the client device.

As shown in FIG. 9, the apparatus for document processing provided in this embodiment mainly includes: a content acquisition module 91, a request sending module 92 and a ubiquitous language updating module 93.

The content acquisition module 91 is configured to acquire edit content in response to receiving an editing operation performed by a first user on a target document.

The request sending module 92 is configured to send a first data request to a server based on the edit content.

The ubiquitous language updating module 93 is configured to update a target content in the edit content to be in a ubiquitous language in response to receiving a ubiquitous language identifier sent by the server, where the ubiquitous language identifier is determined based on the edit content.

According to the embodiments of the present disclosure, the apparatus for document processing is provided for acquiring edit content in response to receiving an editing operation performed by a first user on a target document; sending a first data request to a server based on the edit content; updating a target content in the edit content to be in a ubiquitous language in response to receiving a ubiquitous language identifier sent by the server, where the ubiquitous language identifier is determined based on the edit content. In the embodiment of the present disclosure, once it is identified that the inputted edit content includes a ubiquitous language during the process of editing the online document, the target content in the edit content is automatically updated to be in the ubiquitous language. In this way, the ubiquitous languages in the online document can be managed effectively.

In one embodiment, the ubiquitous language updating module 93 is specifically configured to present a first interaction area, where the first interaction area is associated with the target content in the edit content; and update the target content in the edit content to be in the ubiquitous language in response to receiving a first operation performed by the first user on the first interaction area.

In one embodiment, the ubiquitous language updating module 93 is specifically configured to present a second interaction area, where the second interaction area includes ubiquitous language identifiers associated with the target content in the edit content; acquire a ubiquitous language identifier corresponding to the target content in response to receiving a second operation performed by the first user on the second interaction area; and update the target content in the edit content to be in the ubiquitous language corresponding to the ubiquitous language identifier in response to receiving a third operation performed by the first user on the second interaction area.

In one embodiment, the ubiquitous language updating module 93 is specifically configured to present a third interaction area in a case that a plurality of target contents are included in the edit content, where the third interaction area includes ubiquitous language information associated with the plurality of target contents; match the target contents with corresponding ubiquitous language identifiers, in response to receiving a fourth operation performed by the first user on the third interaction area; and update the target contents in the edit content to be in ubiquitous languages corresponding to the matched ubiquitous language identifiers in response to receiving a fifth operation performed by the first user on the third interaction area.

In one embodiment, the ubiquitous language updating module 93 is further configured to establish an association relationship between the target content in the edit content and the ubiquitous language identifier; and store the association relationship in a mapping relationship table.

In one embodiment, the ubiquitous language updating module 93 is further configured to switch a display mode of the target content in the edit content from a first mode to a second mode in response to a current editing mode being the first mode; or switch the display mode of the target content in the edit content from a third mode to a second mode associated with the third mode in response to a current editing mode being the third mode.

In one embodiment, the request sending module 92 is further configured to send a second data request to the server in response to a triggering operation on the updated target content, where the second data request includes the ubiquitous language identifier and an identifier of the target document.

Correspondingly, the apparatus further includes: a description information display module, configured to present ubiquitous language description information corresponding to the ubiquitous language identifier in response to receiving a second data sent by the server.

In one embodiment, the apparatus further includes: a ubiquitous language display module, configured to display, in the target document, the ubiquitous language, in response to an inserting operation for the ubiquitous language.

In one embodiment, the ubiquitous language display module is specifically configured to present a first operation entry in response to the inserting operation for the ubiquitous language, where the first operation entry is used to acquire a target ubiquitous language; present a second operation entry in response to acquiring the target ubiquitous language; and display, in the target document, the target ubiquitous language, in response to receiving an operation instruction on the second operation entry.

In one embodiment, the ubiquitous language display module is specifically configured to acquire target location information in response to the insertion operation for the ubiquitous language; and display, in the target document, the ubiquitous language, based on the target location information.

In one embodiment, the apparatus further includes: an adding operation response module, configured to receive a name of the ubiquitous language and ubiquitous language description information in response to an adding operation for the ubiquitous language; and a descriptive information sending module, configured to send the name of the ubiquitous language and the ubiquitous language description information to the server, to allow the server to create a corresponding ubiquitous language record.

In one embodiment, the target content is partial or all of the edit content.

According to the embodiments of the present disclosure, the apparatus for document processing can implement the method for document processing provided by any embodiments of the present disclosure, which has corresponding functional modules and beneficial effects for implementing the data processing method.

FIG. 10 is a schematic structural diagram of an apparatus for document processing according to an embodiment of the present disclosure. This embodiment is applicable in management of ubiquitous languages in a document. The apparatus may be implemented by means of software and/or hardware. The apparatus for document processing is configured in the server.

As shown in FIG. 10, the apparatus for document processing provided in this embodiment mainly includes: a request receiving module 101, a ubiquitous language identifier acquisition module 102 and a ubiquitous language identifier sending module 103.

The request receiving module 101 is configured to receive a first data request sent by a client device, where the first data request includes edit content.

The ubiquitous language identifier acquisition module 102 is configured to acquire a ubiquitous language identifier corresponding to the edit content based on the edit content.

The ubiquitous language identifier sending module 103 is configured to send the ubiquitous language identifier corresponding to the edit content to the client device.

In one embodiment, the ubiquitous language identifier acquisition module 102 is specifically configured to perform tokenization processing on the edit content to obtain a plurality of tokens corresponding to the edit content; and determine, by matching each token in a ubiquitous language database, a ubiquitous language identifier corresponding to each token.

In one embodiment, the ubiquitous language identifier acquisition module 102 is specifically configured to perform aggregation processing on data information corresponding to at least one edit content, and determine a total amount of data information after the aggregation processing; and acquire, in a case that the total amount of data information meets a threshold condition, the ubiquitous language identifier corresponding to the edit content.

In one embodiment, the request receiving module 101 is configured to receive a second data request sent by the client device; where the second data request includes a ubiquitous language identifier and an identifier of a target document.

Correspondingly, the apparatus further includes: a query module, configured to query in the ubiquitous language database for ubiquitous language description information corresponding to the ubiquitous language identifier; and
a data sending module, configured to send second data to the client device, where the second data includes the ubiquitous language description information corresponding to the ubiquitous language identifier.

In one embodiment, the second data request further includes: a user identifier; and the apparatus further includes:
a permission determination module, configured to determine whether the user is authorized with permission of the target document based on the user identifier and the identifier of the target document; perform the querying for the ubiquitous language description information corresponding to the ubiquitous language identifier in the ubiquitous language database in response to the user being authorized with the permission of the target document.

In one embodiment, the apparatus further includes:
a description information receiving module, configured to receive a name of the ubiquitous language and ubiquitous language description information sent by the client device.
a name query module, configured to query in a ubiquitous language database based on the name of the ubiquitous language; and
a ubiquitous language database updating module, configured to update the ubiquitous language database based on the name of the ubiquitous language and the ubiquitous language description information, in response to not finding the name of the ubiquitous language.

According to the embodiments of the present disclosure, the apparatus for document processing can implement the method for document processing provided by any embodiments of the present disclosure, which has corresponding functional modules and beneficial effects for implementing the data processing method.

Referring to FIG. 11, FIG. 11 illustrates a schematic structural diagram of an electronic device (e.g., a terminal device or server shown in FIG. 11) that is applicable to implement embodiments of the present disclosure. The terminal device in the embodiment of the present disclosure may include, but is not limited to, mobile terminals, such as mobile phones, laptops, digital broadcast receivers, personal digital assistants (PDAs), tablet computers (PADs), portable multimedia players (PMPs), vehicle-mounted terminals (such as in-vehicle navigation terminals) and the like, and stationary terminals such as digital TVs, desktop computers and the like. It should be noted that the electronic device shown in FIG. 11 is only an example and should not impose any limitations on the functions and scope of use of the embodiments of the present disclosure.

As shown in FIG. 11, the electronic device 1100 may include a processing apparatus (such as a central processor and a graphic processor) 1101. The processing apparatus 1101 may perform various appropriate actions and processing based on programs stored in a read-only memory (ROM) 1102 or programs uploaded from a storage apparatus 1108 to a random access memory (RAM) 1103. Various programs and data required for operations of the electronic device 1100 are also stored in the RAM 1103. The processing apparatus 1101, the ROM 1102 and the RAM 1103 are connected to each other through the bus 1104. An input/output (I/O) interface 1105 is also connected to the bus 1104.

Generally, the following apparatuses may be connected to the I/O interface 1105: an input apparatus 1106 such as a touch screen, a touch panel, a keyboard, a mouse, a camera, a microphone, an accelerometer, and gyroscope; an output apparatus 1107 such as a liquid crystal display (LCD), a loudspeaker and a vibrator; a storage apparatus 1108 such as a magnetic tape and a hard disk; and a communication apparatus 1109. The communication apparatus 1109 may allow the electronic device 1100 to communicate with other device in a wired or wireless manner to exchange data. Although FIG. 11 illustrates the electronic device 1100 provided with various apparatuses, it should be understood that not all shown apparatuses are required to be implemented or included. Alternatively, more or less apparatuses may be implemented or included.

Particularly, according to the embodiments of the present disclosure, the process described above in conjunction with flowcharts may be implemented as a computer software program. For example, a computer program product is further provided according to an embodiment of the present disclosure, including a computer program carried on a non-transitory computer readable medium. The computer program includes the program codes for implementing the methods as shown in the flowcharts. In the embodiment, the computer program may be downloaded and installed from the network via the communication apparatus 1109, or installed from the storage apparatus 1108, or installed from the ROM 1102. When the computer program is executed by the processing apparatus 1101, the functions defined in the methods according to the embodiments of the present disclosure are performed.

It should be noted that, the computer readable medium described in the present disclosure may be a computer readable signal medium, a computer readable storage medium or any combination thereof. The computer readable storage medium may include but not limited to a system, an apparatus or a device in an electric, magnetic, optical, electromagnetic, infrared or a semiconductor form, or any combination thereof. The more specific examples of the computer readable storage medium may include but not limited to electric connection of one or more wires, a portable computer magnetic disk, a hard disk, a random access memory (RAM), a read-only memory (ROM), an erasable programmable read only memory (EPROM or a flash memory), an optical fiber, a portable compact disk read only memory (CD-ROM), an optical storage device, a magnetic storage device or any appropriate combination thereof. In the present disclosure, the computer readable storage medium may be a tangible medium including or storing programs. The programs may be used by an instruction execution system, apparatus or device, or may be used in combination with the instruction execution system, apparatus or device. In the present disclosure, a computer readable signal medium may include a data signal in a baseband or propagated as a part of carrier. The computer readable signal medium carries computer readable program codes. The propagated data signal may be in a variety of forms, and include but not limited to an electromagnetic signal, an optical signal or any appropriate combination thereof. The computer readable signal medium may further be any computer readable medium other than the computer readable storage medium. The computer readable signal medium may send, propagate or transmit programs used by the instruction execution system, apparatus or device or the programs used in combination with the instruction execution system, apparatus or device. The program code embodied in the computer readable medium may be transmitted via any appropriate medium, including but not limited to an electric wire, an optical fiber, radio frequency (RF) or any appropriate combination thereof.

In some embodiments, the client device and the server may perform communication by using any currently known network protocol such as Hyper Text Transfer Protocol (HTTP) or any network protocol to be developed in the further, and may connect with digital data communication (for example, a communication network) in any form or carried in any medium. Examples of the communication network include a local area network (LAN), a wide area network (WAN), Internet, and an end-to-end network (such as, ad hoc end-to-end network), and any currently known or future developed network.

The computer readable medium may be included in the electronic device above or may stand alone without being assembled into the electronic device.

The computer readable medium carries one or more programs. The one or more programs, when executed by the electronic device, cause the electronic device to: acquire edit content in response to receiving an editing operation performed by a first user on a target document; send a first data request to a server based on the edit content; and update a target content in the edit content to be in the ubiquitous language in response to receiving a ubiquitous language identifier sent by the server, and the ubiquitous language identifier is determined based on the edit content.

The computer readable medium carries one or more programs. The one or more programs, when executed by the electronic device, cause the electronic device to: receive a first data request sent by a client device, where the first data request includes edit content; acquire a ubiquitous language identifier corresponding to the edit content based on the edit content; and send the ubiquitous language identifier corresponding to the edit content to the client device.

In an embodiment of the present disclosure, computer program codes for performing operations of the present disclosure may be written by using one or more program design language or any combination. The program design language includes but not limited to object oriented program design language such as Java, Smalltalk and C++, and further includes conventional process-type program design language such as “C” or similar program design language. The program codes may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowcharts and block diagrams in the drawings illustrate architectures, functions and operations which may be implemented by the system, method and computer program product according to the embodiments of the present disclosure. Each block in the flowcharts or the block diagram may represent a module, a program segment or part of codes including executable instruction(s) for implementing specified logic functions. It should be noted that, in some alternative implementations, the functions marked in blocks may be performed in an order different from the order shown in the drawings. For example, two blocks shown in succession may actually be executed in parallel, or sometimes may be executed in a reverse order, which depends on the functions involved. It should also be noted that each block in the block diagram and/or flow chart and a combination of the blocks in the block diagram and/or flow chart may be implemented by a dedicated hardware-based system that performs specified functions or operations, or may be realized by a combination of dedicated hardware and computer instructions.

The units mentioned in the description of the embodiments of the present disclosure may be implemented by means of software or otherwise by means of hardware. A name of the units does not constitute a limitation to the units in some case.

The functions described herein may be at least partially performed by one or more hardware logic components. For example, the hardware logic component may include but not limited to: a field programmable gate array (FPGA), an application specific integrated circuit (ASIC), an application specific standard product (ASSP), a system on chip (SOC), a complex programmable logic device (CPLD) and the like.

It the context of the present disclosure, the machine readable medium may be a tangible medium including or storing programs. The programs may be used by an instruction execution system, apparatus or device, or may be used in combination with the instruction execution system, apparatus or device. The machine readable medium may be a machine readable signal medium or a machine readable storage medium. The machine readable medium may include but not limited to a system, an apparatus or a device in an electric, magnetic, optical, electromagnetic, infrared or a semiconductor form, or any appropriate combination thereof. The machine readable storage medium may include but not limited to electric connection of one or more wires, a portable computer magnetic disk, a hard disk, a random access memory (RAM), a read-only memory (ROM), an erasable programmable read only memory (EPROM or a flash memory), an optical fiber, a portable compact disk read only memory (CD-ROM), an optical storage device, a magnetic storage device or any appropriate combination thereof.

According to one or more embodiments of the present disclosure, a method, apparatus and device for document processing and a medium are provided. The method includes as follows:
acquiring, in response to receiving an editing operation performed by a first user on a target document, edit content;
sending, based on the edit content, a first data request to a server; and
updating, in response to receiving a ubiquitous language identifier sent by the server, a target content in the edit content to be in a ubiquitous language, where the ubiquitous language identifier is determined based on the edit content.

According to one or more embodiments of the present disclosure, a method, apparatus and device for document processing and a medium are provided. The updating, in response to receiving a ubiquitous language identifier sent by the server, a target content in the edit content to be in the ubiquitous language includes:
presenting a first interaction area, where the first interaction area is associated with the target content in the edit content; and
updating, in response to receiving a first operation performed by the first user on the first interaction area, the target content in the edit content to be in the ubiquitous language.

According to one or more embodiments of the present disclosure, a method, apparatus and device for document processing and a medium are provided. The updating, in response to receiving a ubiquitous language identifier sent by the server, a target content in the edit content to be in the ubiquitous language includes:
presenting a second interaction area, where the second interaction area includes ubiquitous language identifiers associated with the target content in the edit content;
acquiring, in response to receiving a second operation performed by the first user on the second interaction area, a ubiquitous language identifier corresponding to the target content; and
updating, in response to receiving a third operation performed by the first user on the second interaction area, the target content in the edit content to be in the ubiquitous language corresponding to the ubiquitous language identifier.

According to one or more embodiments of the present disclosure, a method, apparatus and device for document processing and a medium are provided. the updating, in response to receiving a ubiquitous language identifier sent by the server, a target content in the edit content to be in the ubiquitous language includes:
presenting a third interaction area in a case that a plurality of target contents are included in the edit content, where the third interaction area includes ubiquitous language information associated with the plurality of target contents;
matching the target contents with corresponding ubiquitous language identifiers, in response to receiving a fourth operation performed by the first user on the third interaction area; and
updating the target contents in the edit content to be in ubiquitous languages corresponding to the matched ubiquitous language identifiers, in response to receiving a fifth operation performed by the first user on the third interaction area.

According to one or more embodiments of the present disclosure, a method, apparatus and device for document processing and a medium are provided. The method further includes:
establishing an association relationship between the target content in the edit content and the ubiquitous language identifier; and
storing the association relationship in a mapping relationship table.

According to one or more embodiments of the present disclosure, a method, apparatus and device for document processing and a medium are provided. The method further includes:
switching, in response to a current editing mode being a first mode, a display mode of the target content in the edit content from the first mode to a second mode; or
switching, in response to a current editing mode being a third mode, the display mode of the target content in the edit content from the third mode to a second mode associated with the third mode.

According to one or more embodiments of the present disclosure, a method, apparatus and device for document processing and a medium are provided. The method further includes:
sending, in response to a triggering operation on the updated target content, a second data request to the server, where the second data request includes the ubiquitous language identifier and an identifier of the target document; and
presenting, in response to receiving a second data sent by the server, ubiquitous language description information corresponding to the ubiquitous language identifier.

According to one or more embodiments of the present disclosure, a method, apparatus and device for document processing and a medium are provided. The method further includes:
displaying, in the target document, the ubiquitous language, in response to an inserting operation for the ubiquitous language.

According to one or more embodiments of the present disclosure, a method, apparatus and device for document processing and a medium are provided. The displaying, in the target document, the ubiquitous language, in response to an inserting operation for the ubiquitous language includes:
presenting, in response to the inserting operation for the ubiquitous language, a first operation entry, where the first operation entry is configured to acquire a target ubiquitous language;
presenting, in response to acquiring the target ubiquitous language, a second operation entry; and
displaying, in the target document, the target ubiquitous language, in response to receiving an operation instruction on the second operation entry.

According to one or more embodiments of the present disclosure, a method, apparatus and device for document processing and a medium are provided. The displaying, in the target document, the ubiquitous language, in response to an inserting operation for the ubiquitous language includes:
acquiring, in response to the insertion operation for the ubiquitous language, target location information; and
displaying, in the target document, the ubiquitous language, based on the target location information.

According to one or more embodiments of the present disclosure, a method, apparatus and device for document processing and a medium are provided. The method further includes:
receiving, in response to an adding operation for the ubiquitous language, a name of the ubiquitous language and ubiquitous language description information; and
sending, to the server, the name of the ubiquitous language and the ubiquitous language description information, to allow the server to create a corresponding ubiquitous language record.

According to one or more embodiments of the present disclosure, a method, apparatus and device for document processing and a medium are provided. The target content is partial or all of the edit content.

According to one or more embodiments of the present disclosure, a method, apparatus and device for document processing and a medium are provided. The method further includes:
receiving a first data request sent by a client device, where the first data request includes edit content;
acquiring, based on the edit content, a ubiquitous language identifier corresponding to the edit content; and
sending the ubiquitous language identifier corresponding to the edit content to the client device.

According to one or more embodiments of the present disclosure, a method, apparatus and device for document processing and a medium are provided. The acquiring, based on the edit content, a ubiquitous language identifier corresponding to the edit content includes:
performing tokenization processing on the edit content to obtain a plurality of tokens corresponding to the edit content; and
determining, by matching each token in a ubiquitous language database, a ubiquitous language identifier corresponding to each token.

According to one or more embodiments of the present disclosure, a method, apparatus and device for document processing and a medium are provided. The acquiring, based on the edit content, a ubiquitous language identifier corresponding to the edit content includes:
performing aggregation processing on data information corresponding to at least one edit content, and determining a total amount of data information after the aggregation processing; and
acquiring, in a case that the total amount of data information meets a threshold condition, the ubiquitous language identifier corresponding to the edit content.

According to one or more embodiments of the present disclosure, a method, apparatus and device for document processing and a medium are provided. The method further includes:
receiving a second data request sent by the client device; where the second data request includes a ubiquitous language identifier and an identifier of a target document;
querying, in a ubiquitous language database, for ubiquitous language description information corresponding to the ubiquitous language identifier; and
sending second data to the client device, where the second data includes the ubiquitous language description information corresponding to the ubiquitous language identifier.

According to one or more embodiments of the present disclosure, a method, apparatus and device for document processing and a medium are provided. The second data request further includes: a user identifier; and the method further includes:
determining, based on the user identifier and the identifier of the target document, whether the user is authorized with permission of the target document;
performing, in response to the user being authorized with the permission of the target document, the querying for the ubiquitous language description information corresponding to the ubiquitous language identifier in the ubiquitous language database.

According to one or more embodiments of the present disclosure, a method, apparatus and device for document processing and a medium are provided. The method further includes:
receiving, sent by the client device, a name of the ubiquitous language and ubiquitous language description information;
querying, based on the name of the ubiquitous language, in a ubiquitous language database; and
updating, in response to not finding the name of the ubiquitous language, the ubiquitous language database based on the name of the ubiquitous language and the ubiquitous language description information.

The above description merely illustrates the preferred embodiments of the present disclosure and the technical principles employed. Those skilled in the art should understand that the scope of present disclosure is not limited to the technical solutions formed by certain combination of the above-mentioned technical features, and should also cover other technical solutions formed by any combination of the above-mentioned technical features and any equivalent features without departing from the disclosed concept. For example, a technical solution formed by replacing the features with the technical features disclosed in the present disclosure (but not limited to) with similar functions.

In addition, although the above operations are described in a specific order, it should not be understood that these operations are required to be performed in the specific order or performed in a sequential order. In some conditions, multitasking and parallel processing may be advantageous. Similarly, although multiple implementation details are included in the above descriptions, the details should not be interpreted as limitations to the scope of the present disclosure. Some features described in the context of an individual embodiment may be implemented in combination in an individual embodiment. Otherwise, the features described in the context of an individual embodiment may be implemented individually or in any suitable sub-combination form in multiple embodiments.

Although the subject of the present disclosure has been described according to the structural features and/or logical actions of the method, it should be understood that the subject defined in the claims is not necessarily limited to the features or actions described above. Rather, the specific features and actions described above are only examples of the implementation of the claims.

1. A method for document processing, comprising:
acquiring, in response to receiving an editing operation performed by a first user on a target document, edit content;
sending, based on the edit content, a first data request to a server; and
updating, in response to receiving a ubiquitous language identifier sent by the server, a target content in the edit content to be in a ubiquitous language, wherein the ubiquitous language identifier is determined based on the edit content.

2. The method according to claim 1, wherein the updating, in response to receiving a ubiquitous language identifier sent by the server, the target content in the edit content to be in the ubiquitous language comprises:
presenting a first interaction area, wherein the first interaction area is associated with the target content in the edit content; and
updating, in response to receiving a first operation performed by the first user on the first interaction area, the target content in the edit content to be in the ubiquitous language.

3. The method according to claim 1, wherein the updating, in response to receiving the ubiquitous language identifier sent by the server, the target content in the edit content to be in the ubiquitous language comprises:
presenting a second interaction area, wherein the second interaction area comprises ubiquitous language identifiers associated with the target content in the edit content;
acquiring, in response to receiving a second operation performed by the first user on the second interaction area, a ubiquitous language identifier corresponding to the target content; and
updating, in response to receiving a third operation performed by the first user on the second interaction area, the target content in the edit content to be in the ubiquitous language corresponding to the ubiquitous language identifier.

4. The method according to claim 1, wherein, the updating, in response to receiving the ubiquitous language identifier sent by the server, the target content in the edit content to be in the ubiquitous language comprises:
presenting a third interaction area in a case that a plurality of target contents are included in the edit content, wherein the third interaction area comprises ubiquitous language information associated with the plurality of target contents;
matching the target contents with corresponding ubiquitous language identifiers, in response to receiving a fourth operation performed by the first user on the third interaction area; and
updating the target contents in the edit content to be in ubiquitous languages corresponding to the matched ubiquitous language identifiers, in response to receiving a fifth operation performed by the first user on the third interaction area.

5. The method according to claim 1, further comprising:
establishing an association relationship between the target content in the edit content and the ubiquitous language identifier; and
storing the association relationship in a mapping relationship table.

6. The method according to claim 1, further comprising:
switching, in response to a current editing mode being a first mode, a display mode of the target content in the edit content from the first mode to a second mode; or
switching, in response to a current editing mode being a third mode, the display mode of the target content in the edit content from the third mode to a second mode associated with the third mode.

7. The method according to claim 1, further comprising:
sending, in response to a triggering operation on updated target content, a second data request to the server, wherein the second data request comprises the ubiquitous language identifier and an identifier of the target document; and
presenting, in response to receiving a second data sent by the server, ubiquitous language description information corresponding to the ubiquitous language identifier.

8. The method according to claim 1, further comprising:
displaying, in the target document, the ubiquitous language, in response to an inserting operation for the ubiquitous language.

9. The method according to claim 8, wherein the displaying, in the target document, the ubiquitous language, in response to the inserting operation for the ubiquitous language comprises:
presenting a first operation entry, in response to the inserting operation for the ubiquitous language, wherein the first operation entry is used to acquire a target ubiquitous language;
presenting a second operation entry, in response to acquiring the target ubiquitous language; and
displaying, in the target document, the target ubiquitous language, in response to receiving an operation instruction on the second operation entry.

10. The method according to claim 8, wherein the displaying, in the target document, the ubiquitous language, in response to the inserting operation for the ubiquitous language comprises:
acquiring, in response to the insertion operation for the ubiquitous language, target location information; and
displaying, in the target document, the ubiquitous language, based on the target location information.

11. The method according to claim 1, further comprising:
receiving, in response to an adding operation for the ubiquitous language, a name of the ubiquitous language and description information of the ubiquitous language; and
sending, to the server, the name of the ubiquitous language and the description information of the ubiquitous language, to allow the server to create a corresponding ubiquitous language record.

12. The method according to claim 1, wherein the target content is part of or all of the edit content.

13. A method for document processing, comprising:
receiving a first data request sent by a client device, wherein the first data request comprises edit content;
acquiring, based on the edit content, a ubiquitous language identifier corresponding to the edit content; and
sending the ubiquitous language identifier corresponding to the edit content to the client device.

14. The method according to claim 13, wherein the acquiring, based on the edit content, the ubiquitous language identifier corresponding to the edit content comprises:
performing tokenization processing on the edit content to obtain a plurality of tokens corresponding to the edit content; and
determining a ubiquitous language identifier corresponding to each token, by matching each token in a ubiquitous language database.

15. The method according to claim 13, wherein the acquiring, based on the edit content, the ubiquitous language identifier corresponding to the edit content comprises:
performing aggregation processing on data information corresponding to at least one edit content, and determining a total amount of data information after the aggregation processing; and
acquiring, in a case that the total amount of data information meets a threshold condition, the ubiquitous language identifier corresponding to the edit content.

16. The method according to claim 13, further comprising:
receiving a second data request sent by the client device, wherein the second data request comprises a ubiquitous language identifier and an identifier of a target document;
querying for ubiquitous language description information corresponding to the ubiquitous language identifier, in a ubiquitous language database; and
sending second data to the client device, wherein the second data comprises the ubiquitous language description information corresponding to the ubiquitous language identifier.

17. The method according to claim 16, wherein the second data request further comprises a user identifier, and the method further comprises:
determining, based on the user identifier and the identifier of the target document, whether the user is authorized with permission of the target document;
in response to the user being authorized with the permission of the target document, querying for the ubiquitous language description information corresponding to the ubiquitous language identifier in the ubiquitous language database.

18. The method according to claim 13, further comprising:
receiving a name of the ubiquitous language and ubiquitous language description information sent by the client device;
querying, based on the name of the ubiquitous language, in a ubiquitous language database; and
updating, in response to not finding the name of the ubiquitous language, the ubiquitous language database based on the name of the ubiquitous language and the ubiquitous language description information.

19. A device for document processing, comprising:
one or more processors; and
a memory, configured to store one or more programs;
wherein, the one or more programs, when executed by the one or more processors, cause the one or more processors to implement:
acquiring, in response to receiving an editing operation performed by a first user on a target document, edit content;
sending, based on the edit content, a first data request to a server;
updating, in response to receiving a ubiquitous language identifier sent by the server, a target content in the edit content to be in a ubiquitous language, wherein the ubiquitous language identifier is determined based on the edit content.

20. A device for document processing, comprising:
one or more processors; and
a memory, configured to store one or more programs;
wherein, the one or more programs, when executed by the one or more processors, cause the one or more processors to implement:
receiving a first data request sent by a client device, wherein the first data request comprises edit content;
acquiring, based on the edit content, a ubiquitous language identifier corresponding to the edit content; and
sending the ubiquitous language identifier corresponding to the edit content to the client device.

21. A non-transitory storage medium storing a computer program thereon, wherein the computer program, when executed by a processor, implements the method for document processing according to claim 1.
